(19) United States
(12) Patent Application Publication
(10) Pub. No.: US 2014/0360586 A1
(43) Pub. Date: Dec. 11, 2014

(54) Fluid ionization vaporization inlet for introduction of samples to spectroscopy instruments and methods of performing the same

(71) Applicant: Randall E. Mielke, Los Angeles, CA (US)

(72) Inventor: Randall E. Mielke, Los Angeles, CA (US)

(21) Appl. No.: 14/297,419

(22) Filed: Jun. 5, 2014

Related U.S. Application Data
(60) Provisional application No. 61/831,144, filed on Jun. 5, 2013.

(51) Int. Cl. H01J 49/04

(52) U.S. Cl. CPC H01J 49/0445
USPC 137/13; 137/240; 137/15.04

(57) ABSTRACT

A fluid ionization and vaporization inlet provides for the ionization and vaporization of samples to be delivered to analytical instrumentation of the scientist's choice. A sample may be injected through a septum onto a sample plate whereby heat, direct current, or both can be applied to ionize and/or vaporize the sample into a carrier gas, which is then provided to the analytical instrumentation. A continuous fluid sample may also be provided to the fluid ionization and vaporization inlet wherein it is heated to vaporize the sample, and then excited volatile molecules pass through a gas permeable membrane and combined with a carrier gas, which in turn is provided to the analytical instrumentation.

### CROSS REFERENCE TO RELATED APPLICATIONS

This application claims the benefit of U.S. Provisional Patent App. No. 61/831,144 filed on Jun. 5, 2013, the entirety of which is hereby incorporated by reference.

### BACKGROUND OF THE INVENTION

Field of the invention: This invention relates to the general field of environmental pollution remediation devices, and more particularly towards the technical field of specialized devices used in environmental pollution detection and analysis. A “Fluid Ionization Vaporization Inlet” or “FIVI” is a device that takes a drop of fluid and ionizes the chemicals present in the fluid, and forms an aerosol of the chemicals that can be delivered to analytical instrumentation of the scientist's choice. The FIVI systems can be manufactured in both disposable and non-disposable forms, depending on the fluids being analyzed and other requirements of the analyzation. Furthermore, with the disposable version, the possibility of sample cross-contamination is minimized or even made non-existent for human bodily fluids, including blood, breast milk, and tears.

Exposure to contaminants such as organic chemicals and heavy metals can negatively affect people and ecosystems. Many of these contaminants are toxic and/or can persist for long periods of time. Hazardous chemicals disseminate into the environment from multiple sources over both long and short-terms into all facets of the environment, from aquatic organisms to terrestrial organisms, but most important is the human concentration of these environmental chemicals. Persistent pollutants are toxic organic or metal compounds that are resistant to environmental degradation through chemical, biological, and photolytic processes. Due to this longevity, persistent pollutants are often good candidates for bioaccumulation in organisms. Heavy metal and organic chemical exposures can cause a variety of ailments from neurological dysfunctions, cancer, organ malfunctioning, autism, Alzheimer's, disruption to the endocrine system, etc. which can often lead to severe sickness, metal impairment or even sometime death. Often it can be hard to identify what contaminant is causing these issues since we are constantly exposed to many types of chemicals and heavy metals every day.

In the US alone, more than 80,000 synthetic chemicals are used and only a small fraction of these have been tested for safety, and it is becoming more and more clear that pollution does not respect international borders. Cost and complexity are the major setbacks of identifying and understanding the point sources of chemical and heavy metal exposures that cause human and environmental health challenges. Currently analyses of these kinds of samples are very costly and time consuming to perform in laboratories and even harder in the fields. Current technologies, such as; Gas chromatography-mass spectrometry (GC-MS), or Mass spectrometry-mass spectrometry (MS-MS), Fourier transform infrared spectroscopy (FTIR), and Ultraviolet-visible spectrophotometry (UV/Vis), Inductively coupled plasma mass spectrometry (ICP-MS) that are utilized to detect and/or quantify contaminant loads in liquid samples often take long extraction protocols that require highly trained technical staff to remove compounds that may interfere with the detection systems and create large amounts of sample loss. This causes many setbacks in determination of point sources of contaminants and reduces ability to prevent or stop human health and environmental damage.

The FIVI system significantly reduces these costs by allowing for minimal sample preparation, while the size and ease of use of the FIVI system allows for analysis operations to occur by less staff with reduced training One advantage of the FIVI sample introduction systems is the ability to generate an aerosol-ionized sample that makes matrix effects, as described previously, minimized or even eliminated, while minimizing sample loss before the introduction into many potential different available conventional analytical instruments. This allows for many samples to be analyzed for a small fraction of existing costs and expedites the ability to look for complex point sources of contaminants or allow for the ability to not only identify what organic chemical or heavy metal are present, but allow for the ability to pinpoint which of these compounds may be the cause of human or environmental health issues. One significant advantage of the FIVI sample introduction systems is the ability to generate an aerosol-ionized sample that eliminates, or at the very least significantly minimizes the matrices effects.

Spectrometers are very expensive machines, both in terms of the initial purchase price and operating time, so it is highly desirable to have a pure sample that can be prepared quickly and with a low overhead. Because under the current methods of sample preparation the matrices effect often involves having other chemicals present in the fluid matrix interfering with the spectrometer's ability to actually read the desired sample, the result will be the undesirable reduction of signal strength at the spectrometer. The FIVI system requires no sample preparations, functionalization or isolation methods, which minimizes sample loss before the introduction into the different available conventional analytical spectrometer instruments.

Presently, the ability to take a fluid sample from a wide variety of environmental ecosystems and analyze for environmental chemicals is complicated due to the large variability of fluid matrices that will be encountered in the environment sample. A fluid matrix is a body of liquid comprised of, usually, single or numerous liquid types combined with a variety of suspended organic and inorganic substances—sort of a liquid soup, so to speak, in which the key substances that a researcher wants to study are contained. Liquid samples can come from a variety of sources such as human body fluids, salt water, fresh water, soil extractions, animal fluids, prokaryotic and single cell organism mixtures, and synthetic media. These different liquid matrices can contain compounds that interrupt detection signals, mask chemicals of interest, or clog up the very sensitive detection systems. Conventional analytical laboratory procedures to remove or analyze these varied environmental fluid matrices are cost-prohibitive due to the number and lengthy time of procedures needed to remove these unwanted elements in samples, the expensive laboratory chemicals needed to do these procedures, the legal requirements imposed by Environmental Health and Safety Standards, and the cost of the highly trained, technical staff needed to professionally perform these operations.

The FIVI's ability to quickly analyze a very small liquid sample (a single drop) of multiple matrices types with little to no sample preparation with a very easy to use, disposable system makes analyses of liquid samples cost effective. The simplicity of the invention does not require highly trained (and expensive) personnel to operate, and allows for 24 hours a day, 7 days a week operation. Presently, the ability to take a fluid sample from a wide variety of environmental ecosystems and analyze for environmental chemicals is complicated due to the large variability of fluid matrices that will be encountered in the environment sample. Conventional analytical laboratory procedures to remove or analyze these varied environmental fluid matrices is cost prohibitive. The FIVI's ability to utilize almost any environmental fluid, including blood, urine, and salt or fresh water aquatic samples, makes analyses of environmental chemicals in multiple sample matrices cost effective and allows for continuous operation without the requirement of highly trained laboratory technicians.

In a composition of liquid matrices, each chemical has a unique physical size, an orientation of functional groups and an elemental composition that makes it unique from all other molecules. The functional groups of a molecule are specifically charged with positive or negative charges, producing a net molecule charge and a net molecule polarity that is in opposition with functional groups on other molecules or the same molecule that are uncharged and are considered non-polar or non-polar regions of a molecule. The basis for most modern analytical techniques is dependent upon the interaction of molecules with surfaces by these functional groups relative to the mass though a very thin straw structure. These straw structures are made from a variety of chemical surfaces that are covered by either polar or non-polar structures. The straw surface structures often require time-consuming, chemical alterations to add a functional group, to physically irreversibly bind a chemical to these functional groups, to change the molecules' surface property, or for specific sample isolation steps to remove the non-polar or polar molecule in question, which is required before a sample can be analyzed.

The isolation of specific molecules or chemicals from a sample can be quite difficult due to matrices surrounding the desired chemical, and this difficulty takes on different forms depending on the specific analytical technique being used. For example, the high sodium and chloride ion content of salt water makes it impossible to use a straw structure that has functional groups that are required to reversibly bind the analyzed chemicals. The binding of sodium or chloride preferentially will not allow the binding of the chemicals that are flowing through the straw structure at minute concentrations compared to the sodium and chloride concentrations. As more physical steps are required to functionalize or isolate the chemical being analyzed, there is a corresponding increase in the chance of an unintended loss of sample and contaminants of interest. Such a loss is considered acceptable in most analytical labs, thereby necessitating the need for an initial larger sample, and the need for more complex scientific instruments (each being run by highly trained and expensive laboratory technicians). Through the FIVI sample introduction system, because the fluids are loaded directly, there is no sample loss as there is no need for complex sample preparation through functionalization or isolation methods to change the sample matrices.

When an environmental sample is solid sediment, the FIVI only requires dissolution of the sample before application on sample filter paper, while previous procedures and technology for these types of spectroscopic analyses take highly trained technical staff for operation. The straw structures or reaction columns are constructed differently depending on the chemical class, whether the molecule is polar or non-polar, the strength of binding properties of functional group on column, and required column preparation steps that remove unwanted chemicals while functionalizing the surface properly for the new sample. The complexity of these operations requires that the laboratory technicians operating the scientific instruments have extensive chemistry backgrounds to run the samples and to understand the problems that they may be faced with different sample matrices. The FIVI system, on the other hand, requires minimal technical staff experience for use due to its simplistic “one-drop of sample” design and lack of extensive standard operating procedures (SOP's) needed for sample preparation. This allows for the bulk of the analyses time to be done by lesser trained and relatively inexpensive technicians, while the highly trained technical staff's time can be applied toward the of operation of the analytical instrument in use. Thus, the invention provides major improvements upon the prior art in terms of not only the sample size needed, but also in the minimization of chances for contamination. The invention also provides significant savings in terms of personnel, as no longer are highly trained and expensive technicians required just to get the sample to the point where it can be tested.

### SUMMARY OF THE INVENTION

The current invention provides a unique technology development for the introduction of vaporized ionized chemicals into analytical spectrometers. As discussed previously, obtaining a contaminant-free sample for analysis by a spectrometer can be, under the current technology, quite difficult, time consuming and expensive. By producing samples of vaporized ionized chemicals, the current invention significantly minimizes all three of these drawbacks to the current methods.

Most spectrometers generate a signal from chemical molecules interfering with a charged surface, which indicates an amplitude or quantity of molecules at that specific time at the column of the detector. Getting the sample into the column can be accomplished with a fluid sample, but the fluid around the sample, called matrix, will influence how or if ever a specific chemical will transverse through the column and at what speed. The matrices effect can be destructive by closing off functional groups on a column making the chemical flow through the column without adequate separation time to be read individually by the spectrometer detector. This is what makes the FIVI sample instruction system ideal for a wide variety of environmental sample matrices because the matrix is deposited on the filter paper, dried, such that the matrix will not have the same effect as when in the fluid phase. The matrices of samples are complex and will vary when generated from environmental ecosystems, including salt and fresh water, body fluids from humans and other living organisms, and solutions generated from soil extraction methods.

The method of removing the problematic matrix is through electricity and vaporization. A direct current (DC) electrical voltage (4 to 5 keV) is instantaneously applied with a power supply to the triangular base of the dried sample filter paper. The DC is only applied after fresh solvent is deposited on the dried sample filter paper. In a particular embodiment, the required solvent is methanol with varied polar water content depending on the sample and the chemicals that are being analyzed for by the spectrometer. A higher concentration of methanol will extract more non-polar chemicals, while an increase in concentration of water will result in higher polar chemicals extraction. The DC power is great enough to cause the ionization of a chemical structure. The ionization can occur by dislodging salts that have charged properties, making surfaces of non-polar molecules electron-rich, which results in forming a new polarity, and by changing the functional group ionic charge, thereby freeing it up to be vaporized. The extracted and ionized chemical contaminants from the sample are then vaporized into small solvent-chemical droplets that are transported in the air stream that is sub-sampled by the varied types of spectrometer used for research. The vaporization of the solvent-chemical is ideal for the introduction of samples into a spectrometer that works optimally when a sample has uniform matrix to ensure proper transverse mobility through the column. The fine vaporized solvent-sample droplets from the FIVI will migrate easier compared to large single droplets applied to the same column by conventional injection introduction methods.

One embodiment of the invention calls for the construction of the FIVI from inert polytetrafluoroethylene (PTFE), also known by its brand name Teflon. This material minimizes sample contamination and is cost effective to make the system case disposable after a specified number of samples. It should be noted, however, that the invention also contemplates a number of alternative materials such as aluminum, stainless steel, carbon fiber, or high-density poly-plastic, each with or without a secondary PTFE coating. The use of chemical solvents to clean non-disposable sample introduction systems causes possible contamination of subsequent samples with residual chemicals. This can result in compromised results as the spectrometer is actually testing more than one “sample” at a time. The development of the FIVI system is ideally suited for being manufactured relatively inexpensively, but producing the same vaporized sample required for optimal spectrometry analysis until the build-up of the previously vaporized samples on the interior chamber surfaces becomes an influence in the analytical results. Previously designed vaporization nozzles deposit liquid directly into a carrier gas high-pressure stream leading to inadequate fine droplet formation that in turn leads to clogging of nozzle and loss of sample.

According to a particular embodiment of the current invention, the internal sample chamber, also called the central chamber, is minimized to reduce the “air to sample chemical dilution factor.” This design feature allows for sampling smaller drops of fluids and for sensitive detection of the environmental chemical contaminants in question, which are sometimes in only trace amounts. The reduction in the air-chemical dilution factor is a major key in fabrication of the airflow-optimized inner chamber. Air is introduced through four gas inlets that are positioned at locations to minimize dead void volumes. An additional air nozzle provides air through a gator clamp, which holds the sample filter paper. These gas inlets and air nozzle are pressure controlled through regulators that are calibrated to generate the largest signal from control samples at the spectrometer. The gator clamp, which is a spring-loaded clamp, is used to conductively connect the power supply DC wire to the sample filter paper along with driving an air stream that is parallel to the filter paper, thereby minimizing cross air currents that could result in sample loss onto the chamber walls. The air current generated by the central air nozzle flows uniformly over the top and bottom of the sample filter paper, thereby maximizing the vaporization of environmental chemicals of the solvent-extracted samples. The vaporized solvent-sample is immediately swept downstream into the outlet, where it can be directly sampled by the spectrometers for analysis. The air pressure is set at an appropriate pressure to maintain fine droplets in the airflow and a way from the, in one embodiment, inert PTFE interior chamber and the PTFE tubing to spectrometer.

The FIVI sample introduction system is a uniquely designed to generate a quantity of chemicals contaminants from the smallest drop of environmental sample that is suitable for spectrometer analysis, regardless of the initial sample matrices. This is true whether the matrix includes salt, high or low pH, and inert or large mass particulates. This invention can be used on a wide variety of spectroscopic instruments while at the same time making an ideally uniform sample matrix specific for the chemicals being investigated. The FIVI can be fabricated from a variety of inert materials and with computer aided design (CAD) drawings to be constructed from many different materials that meet the particular scientific needs. The CAD drawings can be used to automatically mill, while in an alternative embodiment, the FIVI could be three-dimensionally (3D) printed in a very reasonable time frame. In one embodiment, PTFE or another suitable material could be infused into steel molding for mass production.

Spectrometers are very sensitive instruments; thus the results from a spectrometric analysis can be skewed, or even made useless, by contamination from a wide variety of chemicals and materials. These contamination issues can come from lengthy procedures and preparation of the sample, unclean surfaces, non-inert materials on machine parts, or even residue left on the machine or in machine parts that have not been properly cleaned from the last sample. Because spectrometers are so sensitive and contaminants are often not visible to the human eye or even easily found through other detection techniques, cleaning spectrometer systems can be very difficult. The embodiment of the FIVI system that is disposable greatly reduces sample exposure to unwanted contaminant that would skew or nullify the data for that sample. The disposable aspect and in-house production capability of the FIVI systems allows for a great reduction in overall costs that can usually occur from creating such specialized pieces of inert parts. It also reduces contaminants that could be on those parts by reducing the number of individuals involved with the process and distance from production facilities. Because spectrometers are so expensive to purchase and operate, it is highly desirable to provide an invention that avoids, or at least minimizes, the contamination issues that plague the previously used methods. The FIVI can be constructed from a wide variety of materials depending on sample type and chemical contaminants being analyzed for. This is one advantage that makes the FIVI system design a valuable advancement that generates the greatest quantity of detectable chemicals obtained from ever-smaller sized samples.

It is an objective of the current invention to provide a fluid sample introduction system that is relatively inexpensive and time-effective for droplet size samples generated from matrices types including salt and fresh water, blood, urine, saliva, fluid generated from microorganism fluids, and fluids from dissolved soil samples.

It is another objective of the current invention to provide a fluid sample introduction system that is modular in design to be used by scientific instruments with normal operations that initially analyzes gas, vapors and even liquid samples.

A further objective of the current invention is to provide a device that is rugged and dependable, and able to be transported to remote locations with minimal chances of breakage.

An additional objective of the current invention is to provide a physical device that generates an ionized and vaporized sample from a wide range of environmental sample origins and the matrices chemicals that could influence spectroscopic results in destructive manners.

Another objective of the current invention is to provide a device with minimal cost output for each unit thereby making it financially feasible to dispose of FIVI units after a limited number of uses to minimize cross-contamination from previous samples.

It is an additional objective of the current invention to reduce the amount of carrier gasses required during sample introduction by minimizing the unnecessary void volumes at the sample introduction chamber.

Carrier gases are illustrated as ‘air’ for ease in definition in this patent. But it must be understood that the particular carrier gas used with the FIVI system is dependent on the gas used in the spectroscopic instrument, which could be argon, nitrogen, helium or some other gas type used specifically for the particular scientific research and/or application.

The FIVI system introduces a uniform sample that is appropriate for all three sample introduction phases making the many time-consuming and costly required protocols, functionalization or isolation, used during normal operation unnecessary resulting in huge saving in time and money.

A particular embodiment of the current invention includes a fluid ionization vaporization inlet comprising a base, where the base comprises a chamber; a sample plate, where the sample plate is housed within the chamber; a septum alignment plate, where the septum alignment plate mates with the base; an injection septum, where the injection septum mates with the septum alignment plate; a gas inlet, where the gas inlet is in fluid communication with the chamber; a gas outlet, where the gas outlet is in fluid communication with the chamber; and a sample outlet, where the sample outlet is in fluid communication with the chamber. The sample outlet is in fluid communication with the chamber via the gas outlet. The fluid ionization vaporization inlet may further comprise an O-ring, where the O-ring provides a fluid tight seal between the base and the septum alignment plate. The fluid ionization vaporization inlet may further comprise a metal wire, where the metal wire is connected to the sample plate. The sample plate comprises copper. The fluid ionization vaporization inlet may further comprise a peristaltic pump, where the peristaltic pump is in fluid connection with the gas outlet. The fluid ionization vaporization may further comprise a fluid inlet, a heater, where the heater is adjacent to the fluid inlet; a gas permeable membrane, where the gas permeable membrane is in fluid connection with the fluid inlet, where excited volatile molecules within the fluid inlet cross through the gas permeable membrane, where excited volatile molecules that pass through the gas permeable membrane flow through the sample outlet; and a fluid outlet, where the fluid outlet is in fluid connection with the fluid inlet. The fluid ionization vaporization inlet may further comprise a second peristaltic pump, where the second peristaltic pump is in fluid connection with the fluid outlet. The heater is an inline cylindrical ceramic heater that surrounds a portion of the fluid inlet.

Another embodiment of the current invention includes a device comprising a base, where the base comprises a chamber; a gas inlet, where the gas inlet is in fluid communication with the chamber; a gas outlet, where the gas outlet is in fluid communication with the chamber; a sample outlet, where the sample outlet is in fluid communication with the chamber; a fluid inlet; a heater, where the heater is adjacent to the fluid inlet; a gas permeable membrane, where the gas permeable membrane is in fluid connection with the fluid inlet, where excited volatile molecules within the fluid inlet cross through the gas permeable membrane, where excited volatile molecules that pass through the gas permeable membrane flow through the sample outlet; and a fluid outlet, where the fluid outlet is in fluid connection with the fluid inlet. The device may further comprise a sample plate, where the sample plate is housed within the chamber. The device may further comprise a metal wire, where the metal wire is connected to the sample plate. The device may further comprise a septum alignment plate, where the septum alignment plate mates with the base; and an injection septum, where the injection septum mates with the septum alignment plate. The device may further comprise a peristaltic pump, where the peristaltic pump is in fluid connection with the gas outlet. The device may further comprise a peristaltic pump, where the peristaltic pump is in fluid connection with the fluid outlet.

Yet another embodiment of the current invention includes a method of preparing a sample for analyzation comprising the steps of injecting a sample onto a sample plate through an injection septum of a fluid ionization vaporization inlet, where the fluid ionization vaporization inlet comprises a base, where the base comprises a chamber; the sample plate, where the sample plate is housed within the chamber; a septum alignment plate, where the septum alignment plate mates with the base; the injection septum, where the injection septum mates with the septum alignment plate; a gas inlet, where the gas inlet is in fluid communication with the chamber; a gas outlet, where the gas outlet is in fluid communication with the chamber; and a sample outlet, where the sample outlet is in fluid communication with the chamber; and providing a gas through the gas inlet. The method may further comprise the step of applying an electrical direct current to the sample plate. The method may further comprise the step of applying heat to the sample plate. The gas provided through the gas inlet is air. The method may further comprise the step of providing a sample through a fluid inlet, where the fluid ionization vaporization inlet further comprises the fluid inlet, a heater, where the heater is adjacent to the fluid inlet; a gas permeable membrane, where the gas permeable membrane is in fluid connection with the fluid inlet, where excited volatile molecules within the fluid inlet cross through the gas permeable membrane, where excited volatile molecules that pass through the gas permeable membrane flow through the sample outlet; and a fluid outlet, where the fluid outlet is in fluid connection with the fluid inlet.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims.

### BRIEF DESCRIPTION OF THE FIGURES

The accompanying drawings, which are incorporated in and form a part of this specification, illustrate embodiments of the invention and together with the description, serve to explain the principles of this invention.

FIG. 1 is a top view of a FIVI sample introduction system, showing the flow of the sample as it is prepared and delivered to the spectrometer, according to selected embodiments of the current disclosure.

FIG. 2 is a side view of a FIVI sample introduction system according to selected embodiments of the current disclosure.

FIG. 3 is a side close-up view of the nozzle portion of the FIVI according to selected embodiments of the current disclosure.

FIG. 4 is an exploded perspective view of a FIVI according to selected embodiments of the current disclosure.

FIG. 5 is a cutaway top view of a FIVI according to selected embodiments of the current disclosure.

FIG. 6 is a wire-frame perspective view of a FIVI according to selected embodiments of the current disclosure.

FIG. 7 is a cutaway top view highlighting selected portions of a FIVI according to selected embodiments of the current disclosure.

FIG. 8 is a cutaway top view of FIVI units highlighting select functional zones according to selected embodiments of the current disclosure.

FIG. 9 is a cutaway top view of FIVI units further highlighting select functional zones according to selected embodiments of the current disclosure.

### DETAILED DESCRIPTION OF THE INVENTION

Many aspects of the invention can be better understood with the references made to the drawings below. The components in the drawings are not necessarily drawn to scale. Instead, emphasis is placed upon clearly illustrating the components of the present invention. Moreover, like reference numerals designate corresponding parts through the several views in the drawings.

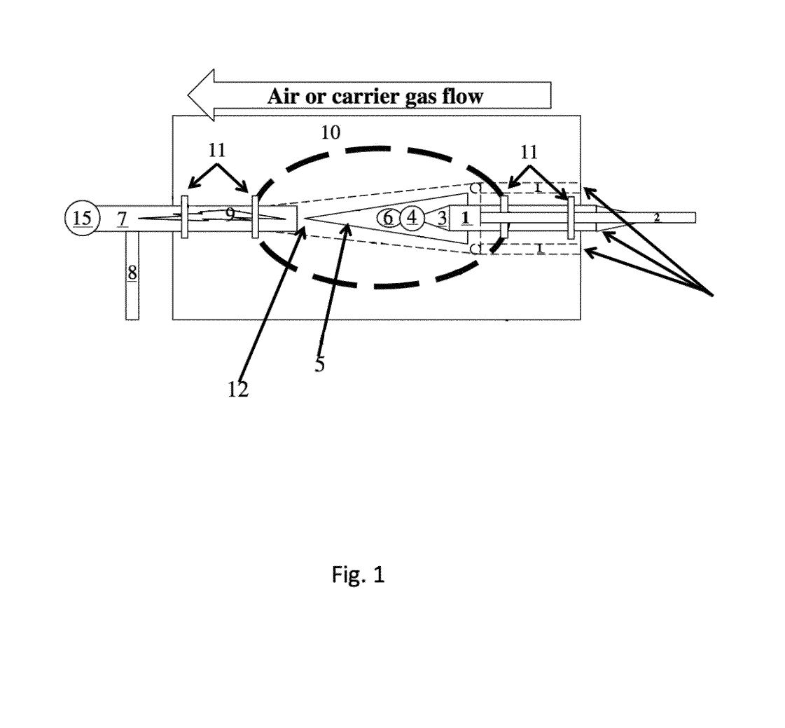

FIG. 1 is a top view of a FIVI sample introduction system, showing the flow of the sample as it is prepared and delivered to the spectrometer, according to selected embodiments of the current disclosure. The FIVI system is constructed of two 1-inch by 2-inch by 4-inch PTFE blocks that can be designed and fabricated on a CAD vertical milling machine. The pressurized air, in a particular embodiment between 2 and 4 pounds per square inch (psi), is directed and calibrated through the nozzle (3) and the four chamber inlets (1) across the dried sample (6) located on the filter paper (5) from right to left (as shown by the large arrow). There are four gas inlets (1) to optimize sample capture in the vapor phase and reduce the void volume cross-contamination in the central chamber (12). The filter paper (5) (triangular shape in this figure, but other shapes of the filter paper or other material from which it is made are contemplated) with the sample (6) has a small quantity of solvent placed thereon, and is then ionized with 4.0 to 5.0 keV DC provided via a wire (2) from a power supply. The solvent is needle-injected through a septum (4) above the sample (6) onto the filter paper (5).

The needle injection method minimizes contamination of airflow during this injection process and allows for multiple injections onto the same sample filter paper, as opposed to wetting the filter paper with the solvent prior to closing chamber. Wetting the filter paper first results in time differences in airflow across the sample leading to varied results. The longer the airflow is applied, the dryer the sample will be before the application of the electrical current. This will result in smaller signal size from samples that apply the solvent after a system is closed and airflow established.

The electrical charge from the wire (2) ionizes the newly solvent released chemicals and vaporizes the ionized chemicals (9), simultaneously. The ionized-vaporized chemicals (9) enter the gas outlet (7) tube and a small aliquot of the ionized-vaporized chemicals (9) is then introduced into the spectrometer via the sample delivery tube (8). The required size of sample is directly dependent on the specific spectrometer sensitivity and is fully adjustable by calibrating the gas outlet valve (15). To generate higher chemical signals at the spectrometer, the gas outlet valve is closed to reach the optimal concentration of sample to air or carrier gas that will deliver the required sample size to be above the spectrometer detection limits specific for the scientific instrument being used.

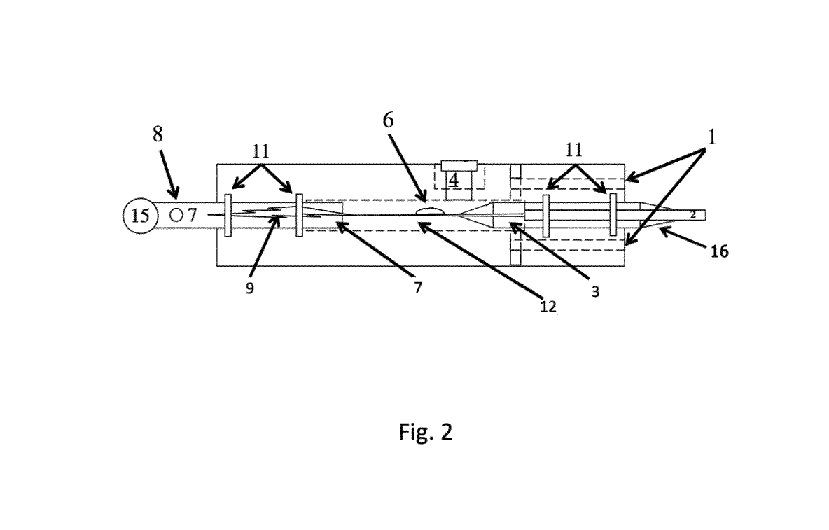

FIG. 2 is a side view of a FIVI sample introduction system according to selected embodiments of the current disclosure. In this view, the two PTFE blocks are mated together by bolts at the four corners. O-rings (11) and large O-ring (10) (shown in FIG. 1 by bold dashed lines) are specially designed to limit the escaping of air from the central chamber (12) (shown in dashed lines) by compression fitting. The O-rings (11) located on the sample holder tube (16) and gas outlet tube (7) are in place to minimize sample loss and align the sample in the central chamber (12) properly.

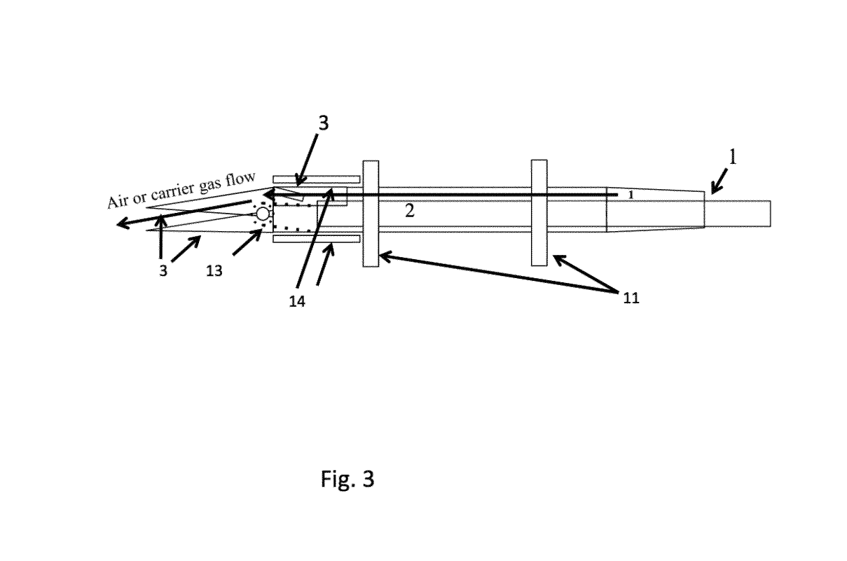

FIG. 3 is a side close-up view of the nozzle portion of the FIVI according to selected embodiments of the current disclosure. The nozzle (3) includes a gator clip (17) that holds the sample (not shown in this figure). The gator clip (17) (also referred to as a gator clamp) is spring loaded via a spring (13) to make sample changes easy and quick. Flexible PTFE tubing (14) around gator clip (17) handle acts as an airflow shield and ensures maximum flow of air to the gator clip attachment point and to the sample filter paper.

In a particular embodiment, the present invention is a volume-optimized inlet system that reduces cross-contamination between sample analyses from residual sample(s) trapped in void volumes. An electrical charge is applied against solvent released chemicals from a sample generated from various types of matrices. The reduction or removal of matrices effects of spectroscopic analyses greatly enhances the ability to analyze chemicals in a wide variety of fluid with minimal sample preparation time. The fluids analyzed through this invention may include without limitation blood, urine, saliva and water samples from fresh and salt-water sources. Other tissue samples can be processed by first breaking tissue encapsulation of fatty tissues, chemically releasing the chemicals, and then introducing it onto sample filter paper to allow the FIVI system to ionize-vaporize the chemicals in that fatty tissue. For example, this process can be used on fish fatty tissue to determine the accumulation of dichlorodiphenyltrichloroethane (DDT) or other pesticides over the life of the fish. The FIVI system will allow spectroscopic analyses of a wide variety of sample types, with minimal sample preparation time, that all adds up to reduced cost for experimentation analysis that can be spent on more analysis in future experiments and possibly increased number of peer-review publications that can be generated.

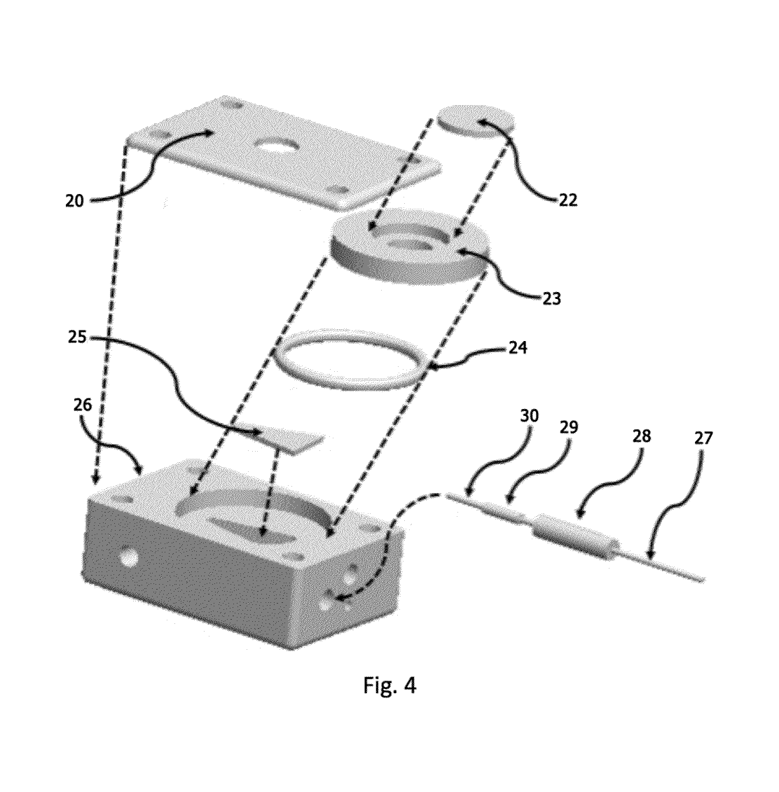

FIG. 4 is an exploded perspective view of a FIVI according to selected embodiments of the current disclosure. A top plate (20) mates with a base (26), each of which has four mating holes. Bolts or screws, not shown in this figure, are used within the holes to secure the top plate (20) to the base (26). A sample plate (25) is housed within the FIVI, adjacent to a septum alignment plate (23) that mates with the base (26). The septum alignment plate (23) includes an O-ring groove (not shown in this figure) and maintains a fluid tight seal with the base (26) via an O-ring (24). A disposable injection septum (22) mates with the septum alignment plate (23). The injection septum (22) is 20 mm in diameter and 2 mm thick, and provides for needle-injection of sample and/or solvent onto the sample plate (25) while otherwise resisting if not eliminating transfer of fluids through the septum. The sample plate (25) has a heater and/or electrical wires connected thereto (not shown in this figure) to aid in the ionization/vaporization process.

The FIVI of FIG. 4 also includes a fluid inlet (27) that connects to a cylinder heater (28), gas permeable membrane (29), and outlet (30). The fluid inlet (27) is made from 1/16 inch stainless steel tubing. The cylinder heater (28) raises the temperature of substance(s) within the fluid inlet (27) to drive gasses across the gas permeable membrane (29). The gas permeable membrane (29) allows gases to flow therethrough while directing excess fluid (including liquid) through the fluid outlet tubing (30). The outlet (30) is made from 1/16 inch stainless steel tubing. Continuous water (or other fluid) samples may be provided through the fluid inlet (27), whereby the heater will vaporize the sample and allow gases resulting therefrom the pass through the gas permeable membrane (29).

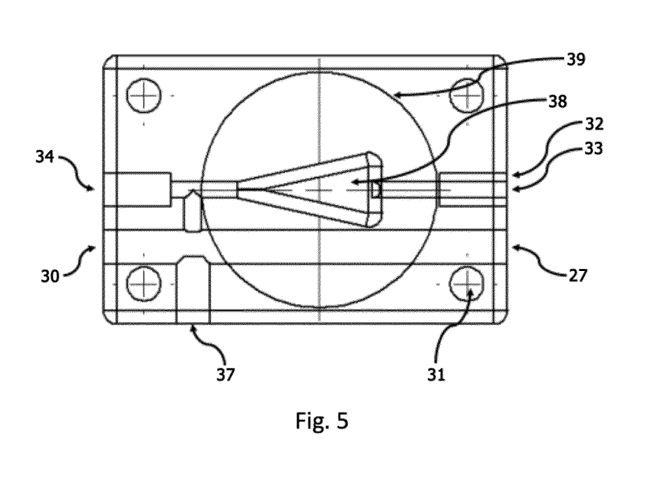

FIG. 5 is a cutaway top view of a FIVI according to selected embodiments of the current disclosure. The base (26) includes four holes (31) through which screws or bolts are used to secure top plate to the base (26). An upper hole (32) has a ¼ inch national pipe thread (NPT) and is used for gas inlet and heater/ionizer wires. A lower hole (33) has a 1/16 inch NPT and allows for a temperature sensor to extend therethrough. A gas outlet (34) having a ¼ inch NPT is provided to release air/excess sample from the FIVI. A fluid inlet (27) and a fluid outlet (30) each has a ¼ inch NPT. A central chamber (38) houses the sample plate, and is where a sample can be ionized and vaporized. The ionized and vaporized gas sample can then be provided through a sample outlet (37) to a spectrometer or other sample analyzing device. The sample outlet (37) has a ¼ inch NPT. Internal area (39) is discussed in more detail below.

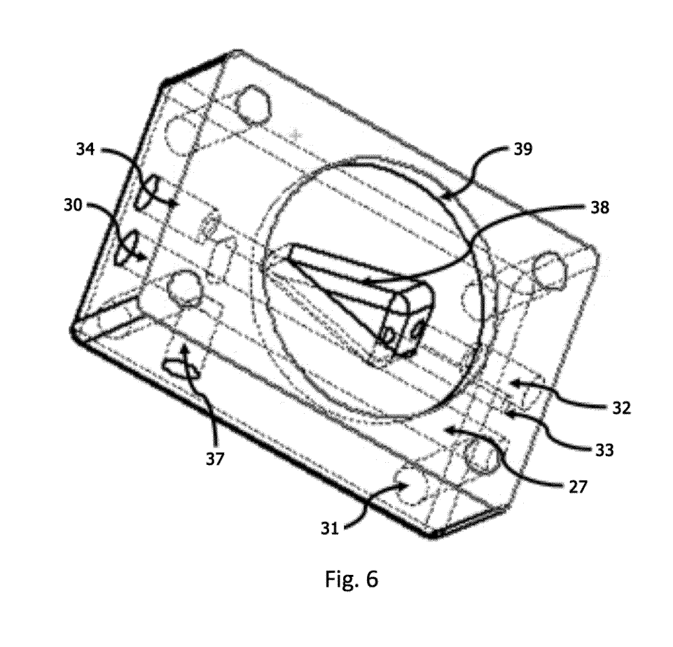

FIG. 6 is a wire-frame perspective view of a FIVI according to selected embodiments of the current disclosure. In addition to the elements discussed above with respect to FIG. 5, this figure shows an internal area (39) that provides for sealing the central chamber (38) and alignment of the septum (not shown in this figure).

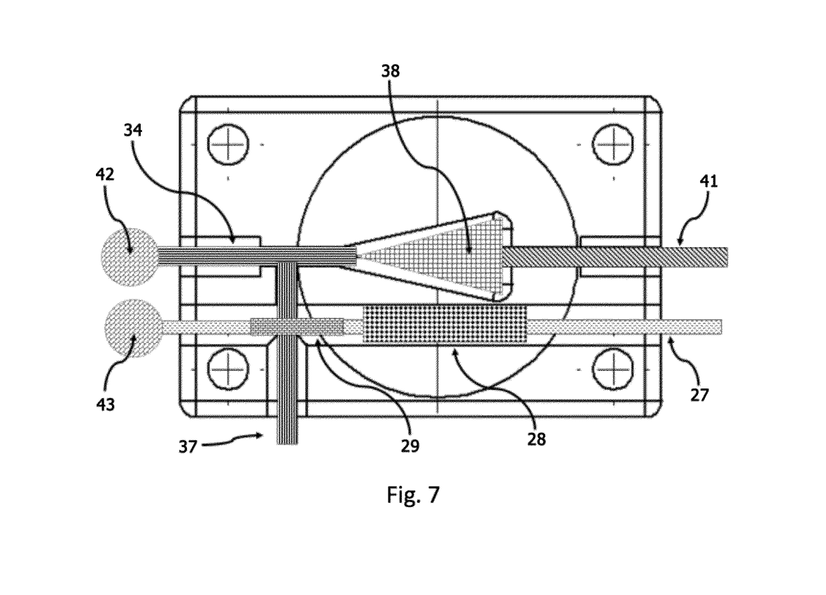

FIG. 7 is a cutaway top view highlighting selected portions of a FIVI according to selected embodiments of the current disclosure. Gas inlet (41) provides gas to the FIVI from a pressurized tank or other carrier of gas. The air (or other gas) flows through the gas inlet (41) into the central chamber (38). The sample plate, which volatilizes, ionizes, or both, is housed within the central chamber (38) and is syringe injected with a sample through a septum. The volatilized or ionized gaseous sample is drawn out through the gas outlet (34) by a peristaltic pump (42). A portion of the volatilized or ionized gaseous sample travels through the sample outlet (37) to a spectrometer or other sample analyzing device.

A continuous fluid sample can also be provided through the fluid inlet (27). The heater (28) excites the internal volatile molecules thereby causing at least a portion of a liquid to vaporize. The vaporized fluid can then travel through the gas permeable membrane (29), through the sample outlet (37), and to a spectrometer or other sample analyzing device. A peristaltic pump (43) draws the fluid sample through the FIVI.

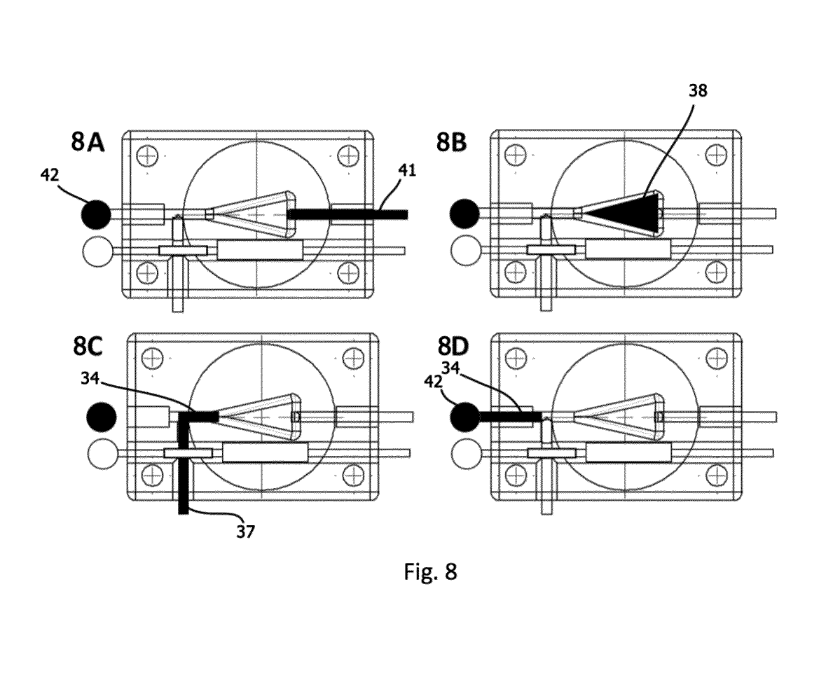

FIG. 8 is a cutaway top view of FIVI units highlighting select functional zones according to selected embodiments of the current disclosure. FIG. 8A highlights the gas inlet (41) and peristaltic pump (42), where the air (or other gas) is provided from a pressurized tank or other carrier gas tank. The peristaltic pump (42) maintains calibrated flow through the gas inlet (41). FIG. 8B highlights the central chamber (38) that houses the sample plate. The sample plate is made from copper. In other embodiments, the sample plate is made from other materials, including without limitation stainless steel. The sample that is to be analyzed is injected onto this sample plate. By raising the temperature of the plate, the sample is volatilized. By applying an electrical current to the plate, the sample is ionized. The volatilized and/or ionized sample then escapes into the surrounding airflow. FIG. 8C highlights the gas outlet (34) and sample outlet (37). After leaving the central chamber, the volatilized and/or ionized sample travels through the gas outlet (34) and at least a portion travels through the sample outlet (37) to a spectrometer or other sample analyzing device. FIG. 8D highlights the gas outlet (34) and peristaltic pump (42). Excess volatilized and/or ionized sample that does not travel through the sample outlet travels and exits the FIVI through the gas outlet (34) and through the peristaltic pump (42).

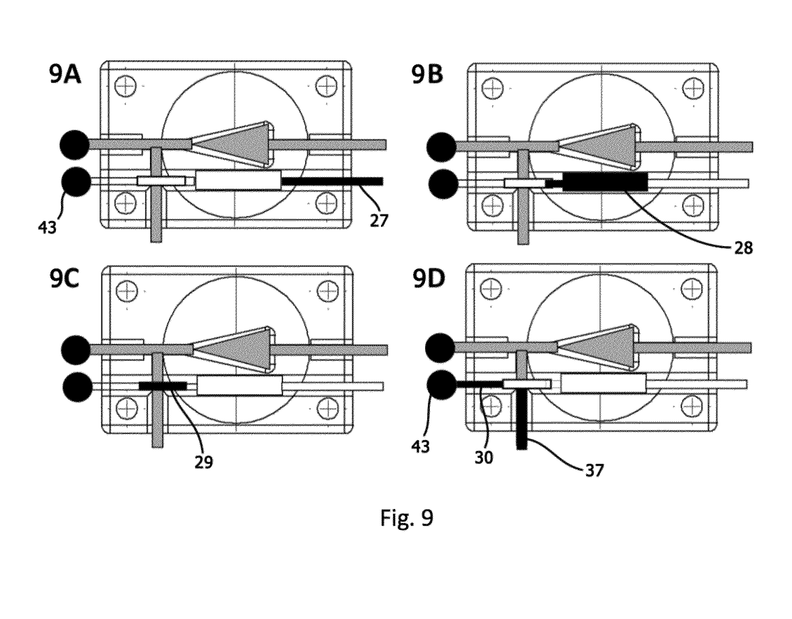

FIG. 9 is a cutaway top view of FIVI units further highlighting select functional zones according to selected embodiments of the current disclosure. Throughout the figures, the stippled areas have a calibrated carrier gas flowing therethrough. FIG. 9A highlights the fluid inlet (27). The sample is introduced through the fluid inlet (27) with the use of the peristaltic pump (43). FIG. 9B highlights the inline cylindrical ceramic heater (28). The heater (28) excites the volatile molecules while inside the stainless steel tubing of the fluid inlet (27). FIG. 9C highlights the gas permeable membrane (29). The excited volatile molecules actively cross the gas permeable membrane (29) into the airflow of the sample outlet (highlighted in FIG. 9D). FIG. 9D highlights the sample outlet (37), fluid outlet (30), and peristaltic pump (43). Excited volatile molecules that cross the gas permeable membrane (29) travel through the sample outlet (37) to a spectrometer or other sample analyzing device, while excess sample flows through the fluid outlet (30). The peristaltic pump (43) draws the sample through the fluid inlet (27) and through the fluid outlet (30).

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

That which is claimed:

1. A fluid ionization vaporization inlet comprising
a base, where the base comprises a chamber;
a sample plate, where the sample plate is housed within the chamber;
a septum alignment plate, where the septum alignment plate mates with the base;
an injection septum, where the injection septum mates with the septum alignment plate;
a gas inlet, where the gas inlet is in fluid communication with the chamber;
a gas outlet, where the gas outlet is in fluid communication with the chamber; and
a sample outlet, where the sample outlet is in fluid communication with the chamber.

2. The fluid ionization vaporization inlet of claim 1, wherein the sample outlet is in fluid communication with the chamber via the gas outlet.

3. The fluid ionization vaporization inlet of claim 1, further comprising an O-ring, where the O-ring provides a fluid tight seal between the base and the septum alignment plate.

4. The fluid ionization vaporization inlet of claim 1, further comprising a metal wire, where the metal wire is connected to the sample plate.

5. The fluid ionization vaporization inlet of claim 1, where the sample plate comprises copper.

6. The fluid ionization vaporization inlet of claim 1, further comprising a peristaltic pump, where the peristaltic pump is in fluid connection with the gas outlet.

7. The fluid ionization vaporization inlet of claim 1, further comprising
a fluid inlet;
a heater, where the heater is adjacent to the fluid inlet;
a gas permeable membrane, where the gas permeable membrane is in fluid connection with the fluid inlet, where excited volatile molecules within the fluid inlet cross through the gas permeable membrane, where excited volatile molecules that pass through the gas permeable membrane flow through the sample outlet; and
a fluid outlet, where the fluid outlet is in fluid connection with the fluid inlet.

8. The fluid ionization vaporization inlet of claim 7, further comprising a peristaltic pump, where the peristaltic pump is in fluid connection with the fluid outlet.

9. The fluid ionization vaporization inlet of claim 7, where the heater is an inline cylindrical ceramic heater that surrounds a portion of the fluid inlet.

10. A device comprising
a base, where the base comprises a chamber;
a gas inlet, where the gas inlet is in fluid communication with the chamber;
a gas outlet, where the gas outlet is in fluid communication with the chamber;
a sample outlet, where the sample outlet is in fluid communication with the chamber;
a fluid inlet;
a heater, where the heater is adjacent to the fluid inlet;
a gas permeable membrane, where the gas permeable membrane is in fluid connection with the fluid inlet, where excited volatile molecules within the fluid inlet cross through the gas permeable membrane, where excited volatile molecules that pass through the gas permeable membrane flow through the sample outlet; and
a fluid outlet, where the fluid outlet is in fluid connection with the fluid inlet.

11. The device of claim 10, further comprising a sample plate, where the sample plate is housed within the chamber.

12. The device of claim 11, further comprising a metal wire, where the metal wire is connected to the sample plate.

13. The device of claim 10, further comprising a septum alignment plate, where the septum alignment plate mates with the base; and an injection septum, where the injection septum mates with the septum alignment plate.

14. The device of claim 10, further comprising a peristaltic pump, where the peristaltic pump is in fluid connection with the gas outlet.

15. The device of claim 10, further comprising a peristaltic pump, where the peristaltic pump is in fluid connection with the fluid outlet.

16. A method of preparing a sample for analyzation comprising the steps of:
injecting a sample onto a sample plate through an injection septum of a fluid ionization vaporization inlet, where the fluid ionization vaporization inlet comprises a base, where the base comprises a chamber; the sample plate, where the sample plate is housed within the chamber; a septum alignment plate, where the septum alignment plate mates with the base; the injection septum, where the injection septum mates with the septum alignment plate; a gas inlet, where the gas inlet is in fluid communication with the chamber; an gas outlet, where the gas outlet is in fluid communication with the chamber; and a sample outlet, where the sample outlet is in fluid communication with the chamber; and
providing a gas through the gas inlet.

17. The method of claim 16, further comprising the step of applying an electrical direct current to the sample plate.

18. The method of claim 16, further comprising the step of applying heat to the sample plate.

19. The method of claim 16, wherein the gas provided through the gas inlet is air.

20. The method of claim 16, further comprising the step of providing a sample through a fluid inlet, where the fluid ionization vaporization inlet further comprises the fluid inlet, a heater, where the heater is adjacent to the fluid inlet; a gas permeable membrane, where the gas permeable membrane is in fluid connection with the fluid inlet, where excited volatile molecules within the fluid inlet cross through the gas permeable membrane, where excited volatile molecules that pass through the gas permeable membrane flow through the sample outlet; and a fluid outlet, where the fluid outlet is in fluid connection with the fluid inlet.
